(19) United States
(12) Patent Application Publication
(10) Pub. No.: US 2024/0296295 A1
(43) Pub. Date: Sep. 5, 2024

(54) ATTRIBUTION VERIFICATION FOR ANSWERS AND SUMMARIES GENERATED FROM LARGE LANGUAGE MODELS (LLMS)

(71) Applicant: Microsoft Technology Licensing, LLC, Redmond, WA (US)

(72) Inventors: James Simon RUSSELL, London (GB); Mary Sugino David PASCH, Seattle, WA (US); Jingtian JIANG, Sammaish, WA (US)

(73) Assignee: Microsoft Technology Licensing, LLC, Redmond, WA (US)

(21) Appl. No.: 18/178,124

(22) Filed: Mar. 3, 2023

(51) Int. Cl. G06F 40/40; G06F 16/903; G06F 16/9038; G06F 16/93; G06F 40/166; G06F 40/284

(52) U.S. Cl. CPC G06F 40/40; G06F 16/90344; G06F 16/9038; G06F 16/93; G06F 40/166; G06F 40/284

(57) ABSTRACT

Systems and methods for verifying attribution of quotations, generated by a large language model (LLM), to a source document are disclosed herein. Upon a request to summarize a source document or process a question that is answerable from a document, an LLM prompt is formed with the request or question along with the content of the source document. The LLM prompt is configured to cause an LLM to generate quotes that are intended to be from the source document. The output of the LLM, including the quotes, is then verified against the source document.

### BACKGROUND

Documents may often contain large amounts of data that would be time consuming to read and comprehend. As such, the ability to summarize the contents of documents is desirable. When a summary of the document is provided, however, the summary must be accurate and supported by the actual contents of the documents. It is with respect to these and other considerations that examples have been made. In addition, although relatively specific problems have been discussed, it should be understood that the examples should not be limited to solving the specific problems identified in the background.

### SUMMARY

The present technology provides, among other things, programmatic solutions to reducing the likelihood that a large language model (LLM) will return hallucinated content and/or verifying that the responses produced by the LLM are actually supported by the document for which the request was generated. For instance, an LLM prompt for requesting the summarization of a source document and/or providing a question about the source document is generated to encourage the reduction of hallucinated content from the LLM. In some cases where specific instructions are provided in the prompt for the LLM to produce only verbatim quotes, the LLM may still hallucinate elements of its responses. With the present technology, the quotes and/or statements in the outputs from the LLM may be programmatically verified and checked against the source document.

For example, the output from the LLM is parsed to identify asserted quotes from within the output. A query is then performed against the source document to determine if the identified quotes are actually supported by the document. Visual indicia may then be included with the output of the LLM to indicate the reliability of the output from the LLM. Links to the portions of the source document may also be provided adjacent the verified quotes to provide direct access to the corresponding portion of the source document. By implementing such improvements in prompt generation and output verification, the overall likelihood of hallucinations is reduced, and when such hallucinations do occur, their potential negative effect of conveying inaccuracies is reduced or removed entirely.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a system for source document attribution verification.

FIG. 2 is a block diagram of example components source document attribution verification.

FIG. 3 depicts an example application user interface for a productivity application displaying a source document and a verified LLM output.

FIGS. 4A-4B depict an example method for performing source document attribution verification.

FIG. 5 is a block diagram illustrating example physical components of a computing device with which aspects of the disclosure may be practiced.

### DETAILED DESCRIPTION

Documents may often contain large amounts of data that would be time consuming to read and comprehend. As such, the ability to summarize the contents of documents or provide tools to answer questions about the documents have become desirable. One option for generating the summaries or answers to such questions about the documents is through the use of a large language model (LLM). For example, a summarization request and/or a question about the document is provided as input to the LLM. The LLM then generates a summary and/or an answer to the question. Due to the massive amount of data upon which the LLM has been trained, there is a possibility that the summary and/or answer generated by the LLM may not actually be supported by the document. Instead, the summary and/or answer that is produced may be hallucinated or confabulated by the LLM itself. In an example, with respect to LLMs, “hallucinated content” refers to content that was not in the source document that was provided to the LLM. Such hallucinated content may convey inaccurate and unreliable results.

The present technology provides, among other things, programmatic solutions to reducing the likelihood that the LLM will return hallucinated content and/or verifying that the responses produced by the LLM are actually supported by the document for which the request was generated. For instance, the prompt for requesting the summarization and/or providing a question about the document is generated to encourage the reduction of hallucinated content from the LLM. As an example, the prompt may request the responses primarily in the form of verbatim quotes from the source document. In some examples, the prompt can also be configured to generate citations or source indicators for the quotes that are provided. Additional limiting language may also be incorporated in the prompt to further reduce the possibility of hallucinated content.

In some cases where specific instructions are provided in the prompt for the LLM to produce only verbatim quotes, the LLM may still hallucinate elements of its responses. For instance, even where sources for quotes or statements are provided in the outputs of the LLM, the quotes or statements are still often not substantiated by the source document when investigated. With the present technology, the quotes and/or statements in the outputs from the LLM may be programmatically verified and checked against the source document.

For example, the output from the LLM may be parsed to identify asserted quotes from within the output. A query is then performed against the source document to determine if the identified quotes are actually supported by the document. Visual indicia may be included with the output of the LLM to indicate the reliability of the output from the LLM. Links to the portions of the source document may also be provided adjacent the verified quotes to provide direct access to the corresponding portion of the source document. In some examples, the non-verified portions of the output may be removed before the output is displayed, and/or the prompt may be revised and/or resubmitted to the LLM to generate a second output from the LLM. By implementing such improvements in prompt generation and output verification, the overall likelihood of hallucinations is reduced, and when such hallucinations do occur, their negative effect of potentially conveying inaccuracies is reduced or removed entirely.

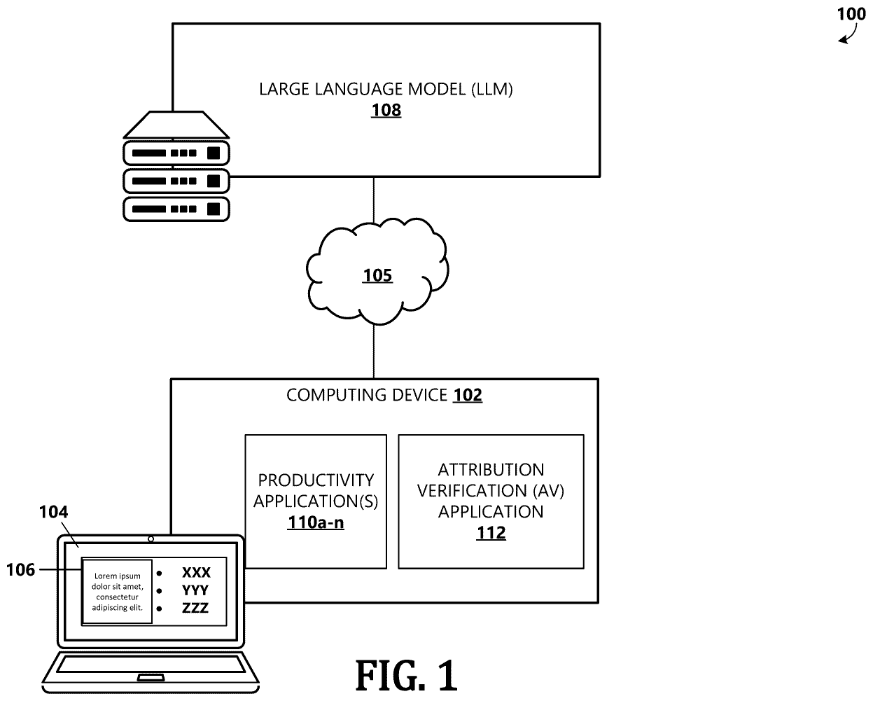

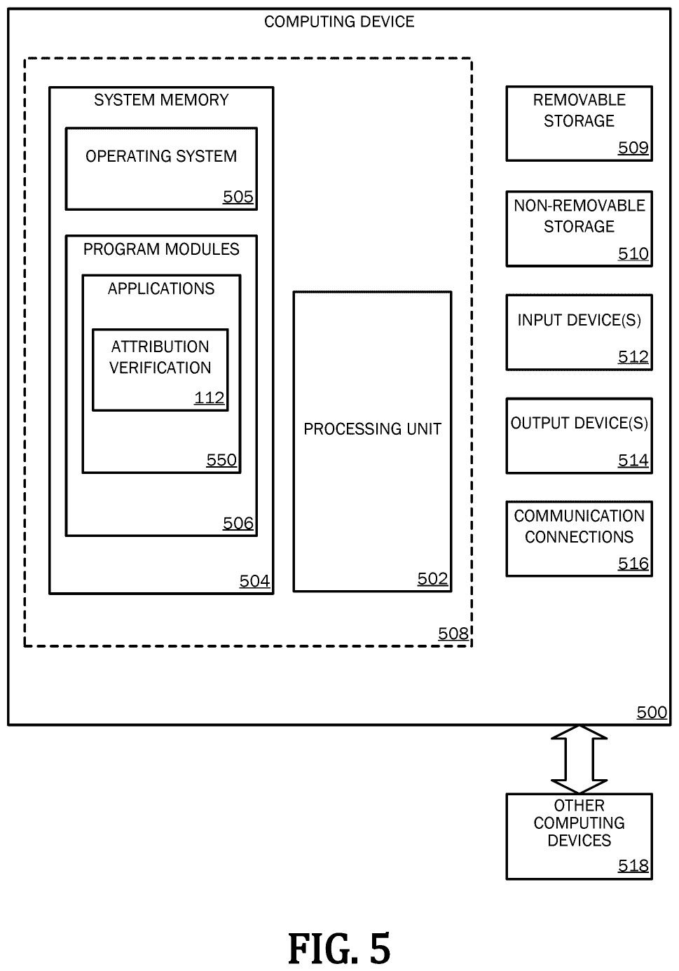

FIG. 1 is a block diagram of an example system 100 is a block diagram of a system for source document attribution verification. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIG. 5. In another example, the components of systems disclosed herein are distributed across multiple processing devices. For instance, input may be entered on a user device or client device and information may be processed on or accessed from other devices in a network, such as one or more remote cloud devices or web server devices.

The example system 100 generates, from an LLM, summaries or answers for source documents and verifies quotations within those summaries or answers. According to an aspect, the system 100 includes a computing device 102 that may take a variety of forms, including, for example, desktop computers, laptops, tablets, smart phones, wearable devices, gaming devices/platforms, virtualized reality devices/platforms (e.g., virtual reality (VR), augmented reality (AR), mixed reality (MR)), etc. The computing device 102 has an operating system that provides a graphical user interface (GUI) that allows users to interact with the computing device 102 via graphical elements, such as application windows (e.g., display areas), buttons, icons, and the like. For example, the graphical elements are displayed on a display screen 104 of the computing device 102 and can be selected and manipulated via user inputs received via a variety of input device types (e.g., keyboard, mouse, stylus, touch, spoken commands, gesture).

In examples, the computing device 102 includes a plurality of productivity applications 110a-n (collectively, productivity applications 110) for performing different tasks, such as communicating, information generation and/or management, data manipulation, visual construction, resource coordination, calculations, etc. As an example, the productivity applications 110 can include, but are not limited to, a word processing application, a presentation application, a graphics application, a database application, a spreadsheet application, a web browser, enterprise software, an information worker application, a multimedia application, a content access application, and the like. The productivity application(s) 110 may be local applications or web-based applications accessed via a web browser. Each productivity application 110 has one or more application UIs 106 by which a user can view application data and interact with the productivity application 110. For example, an application UI 106 may be presented on the display screen 104, and the application UI 106 may display the content of a source document and a sidebar or interface for requesting information about the document. In some examples, the operating environment is a multi-application environment by which a user may view and interact with multiple productivity applications 110 through multiple application UIs 106.

According to examples, the system 100 further includes an attribution verification (AV) application 112 that generates prompts for requesting data about a source document and verifies quotes returned in the output(s) received from an LLM 108 in response to the generated prompt. In some implementations, the AV application 112 is included in one or more productivity applications 110. The AV application 112 may be a separate module that is communicatively integrated into one or more productivity applications 110 via an application programming interface (API). As will be described in further detail below, the AV application 112 provides functionality for generating a prompt based on user input, providing the prompt as input to the LLM 108, and postprocessing the responsive output from the LLM 108 to verify that attributions in the output are actually within the source document.

According to example implementations, the LLM 108 is a generative machine learning model trained to understand and generate sequences of tokens, which may be in the form of natural language (e.g., human-like text). In various examples, the LLM 108 can understand complex intent, cause and effect, perform language translation, semantic search classification, complex classification, text sentiment, summarization, summarization for an audience, and/or other natural language capabilities.

The LLM 108 may be in the form a deep neural network that utilizes a transformer architecture to process the text it receives as an input or query. The neural network may include an input layer, multiple hidden layers, and an output layer. The hidden layers typically include attention mechanisms that allow the LLM 108 to focus on specific parts of the input text, and to generate context-aware outputs. The LLM 108 is generally trained using supervised learning based on large amounts of annotated text data and learns to predict the next word or the label of a given text sequence.

The size of a LLM 108 may be measured by the number of parameters it has. For instance, as one example of an LLM, the GPT-3 model from OpenAI has billions of parameters. These parameters are the weights in the neural network that define its behavior, and a large number of parameters allows the model to capture complex patterns in the training data. The training process typically involves updating these weights using gradient descent algorithms, and is computationally intensive, requiring large amounts of computational resources and a considerable amount of time. The LLM 108 in examples herein, however, is pre-trained, meaning that the LLM 108 has already been trained on the large amount of data. This pre-training allows the model to have a strong understanding of the structure and meaning of text, which makes it more effective for the specific tasks discussed herein.

In example implementations, the LLM 108 operates on a device located remotely from the computing device 102. For instance, the computing device 102 may communicate with the LLM 108 using one or a combination of networks 105 (e.g., a private area network (PAN), a local area network (LAN), a wide area network (WAN)). In some examples, the LLM 108 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

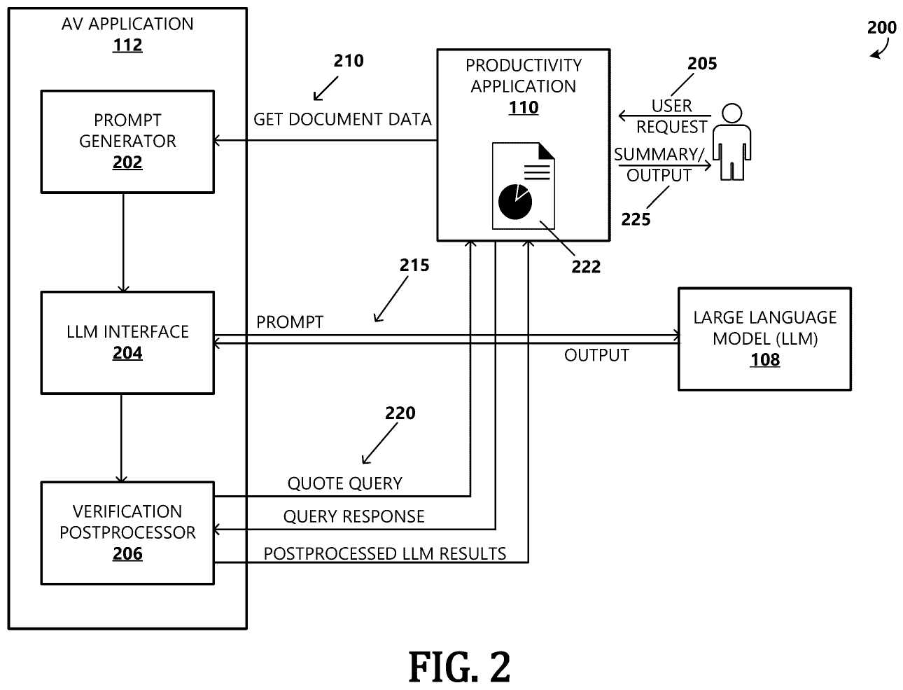

FIG. 2 is a block diagram illustrating example components of the AV application 112 and an example data flow 200. As depicted, the AV application 112 includes a prompt generator 202, an LLM interface 204, and a postprocessor 206. A user may use a productivity application 110 to create, read, and/or edit a source document 222. The source document 222 may be any corpus of data, such as a word processing document, web page, or other types of documents.

Data communication 205 represents a user request for information about the source document 222. For example, the user request may be for a summary of the source document 222 and/or a question about the source document 222 (e.g., a question that can be answered directly from the content of the source document 222). The user request may be in the form of free form text and/or the selection of UI element from the within the application UI 106.

Data communication 210 represents a communication between the productivity application 110 and the prompt generator 202 of the AV application 112. The prompt generator 202 receives the content of the source document 222 along with the request for information about the source document. The prompt generator 202 then generates an LLM prompt from the content of the source document 222 and the request for information about the source document 222. In some examples, the prompt generator 202 may be triggered to generate an LLM prompt without any user input being provided to the productivity application 110. For instance, when the source document 222 is first accessed (e.g., opened. previewed, loaded), the productivity application 110 may automatically request a summary of the source document 222.

The prompt generator 202 may generate the LLM prompt based on one or more templates that correspond to the different types of requests. For instance, a summary template may be used for generating an LLM prompt to produce a summary of the document, and a question template may be used for generating an LLM prompt to produce an answer to a question about the document. The LLM prompt is generated to cause the output of the LLM prompt to include verbatim quotes from the source document 222 and/or source identifiers for the statements or quotes within the output.

The LLM prompt includes the content from the source document, the interrogation request (e.g., question or summarization request), and instructions for inclusion of verbatim quotes from the source document. The prompt may also include additional context that includes prior turns in response to user input. One example structure for a question prompt template is as follows:

```
After reading the following document and the conversation history, you
are going to answer this question: {{Input_Question}}
<Document>
  {{Body Content}}
</Document>
<Conversation History>
  {{Prior Questions/Answers}}
</Conversation History>
Now please answer this question: {{Input_Question}}
When you answer the question, you MUST follow these instructions.
<Instructions>
  -Answer the question using the information from the above document
  only.
  -If the answer is in the above document, include inline citations to the
source text in your answer.
  -If the answer isn't contained in the document above, say: “The answer
to this question isn't in the document, ” and add <|endoftext|>
  -Output the verbatim text to support your answer as a reference at the
end of your answer.
  -Just provide the best answer.
  -Do not output other options.
</instructions>
```

In the above example template, the {{Input_Question}} is filled with the question that is received from user interface, such as the application UI 106. The {{Body Content}} filled with the content of the source document. Unlike other technologies, the LLM itself may not have access or the capability to access, retrieve, and/or separately references source documents. Rather, because the LLM operates over the string of tokens provided directly in the prompt, the actual content of the source document is included within the prompt itself. The </Conversation History> provides additional context to the LLM about previous turns (e.g., questions or requests) for the document, and the {{Prior Questions/Answers}} is filled with those prior questions and, in some examples, the answers or responses provided to those questions.

The <Instructions> provide specific elements that encourage the LLM to produce accurate, verifiable results. For instance, the instructions clarify that answers are only to be drawn from the document that is included in the prompt. The instructions further clarify that the answer should be in the form of verbatim text. The format of the output is also defined within the instructions. For example, the position of the citations (e.g., source identifiers) is defined within the instructions. The instructions also include a path for when an answer cannot be identified from the document within the prompt. Incorporation of such a non-identifiable answer path further encourages the LLM to not provide erroneous or hallucinated results when the answer is not clearly within the document in the prompt.

Other instructions may include formatting requests, such as to bold the verbatim text that is provided in the output. In addition, to further encourage the LLM to generate only verbatim quotes, emphasis symbols may be added around the term verbatim, such as including **verbatim** in the instructions where the * symbol operates to indicate emphasis. Other alternative or additional instructions for generating differently formatting outputs may include at least one of the following:
If the answer is in the above document, include inline citations to the source text in the format of footnotes, i.e., “answer [\hat{ }fn]”.
Output the exact sentences to support your answer as footnotes like “[\hat{ }fn]: quote” and put each footnote into a separate html section.

The above additional instructions cause the quotes and the source identifiers (e.g., [\hat{ }fn]) have a specific and identifiable format. This format allows for easier and more repeatable identification and extraction of the quotes for later verification postprocessing. The source identifiers can also more easily be identified and converted into selectable links for display.

Prompt templates for summarization requests may be similar to the prompt templates for answering a question and may include one or more of the same or similar elements as the question template discussed above. An example summarization prompt template is provided below:
#Document
   File Name: {{Filename}
   Filepath: {{Path}}
   Filecontent: {{Body Content}}
#Instructions
   Considering only the document above, generate one representative sentence from the document as a summary of the document.
   Include at least one verbatim quote from the above document to support the representative sentence.
   Just provide the best one, no other options
   The text must be unformatted

In the above example, the {{Filename} and {{Path}} are filled with the respective file name and file path for the source document. The {{Body Content}} is filled with the content of the document.

Data communication 215 represents communications between the LLM interface 204 and the LLM 108. The generated prompt is provided to a LLM interface 204 of the AV application 112. The LLM interface 204 provides the LLM prompt as input to the LLM 108. The LLM 108 processes the LLM prompt to generate an output. The output includes either an answer to the question about the source document 222 and/or a summary of the source document 222. In some examples, the output includes text output, which may be provided in a variety of formats, such as a JavaScript Object Notation (JSON) format or a HyperText Markup Language (HTML) format.

The LLM output also includes one or more quotes from the source document 222. The quotes may be formatted based on the instructions and/or example outputs provided within the LLM prompt. For example, the quotes may be provided within quotation marks. The quotes may also have different font properties and/or other features that allow for the quotes to be identifies separately from other content of the output.

Source identifiers (e.g., citations, footnotes) may also be provided with each of the quotes in the output. The source identifiers may have a consistent formatting that allows the source identifiers to be identified from within the output. The source identifiers identify a location of the quote from within the source document.

The output of the LLM 108 is received by the LLM interface 204, and the output is transferred to the verification postprocessor 206. The verification postprocessor 206 performs additional operations on the LLM output to verify that the content within the LLM output is properly attributed to the source document 222. The verification postprocessor 206 may also make further modifications to the output to generate a responsive result for display within the application UI 106.

To perform the attribute verification, the verification postprocessor 206 parses the output to identify the asserted verbatim quotes within the LLM output. Such parsing may search for delimiters or other identification elements that identify the quotes within the LLM output. For instance, the parsing may extract text within quotation marks and/or text that has a formatting set forth in the prompt to be indicative of quotations (e.g., bolding). Where source indicators are included, the source indicators may also be used in the parsing process to signify or identify quotations.

For each identified asserted quote, the verification postprocessor 206 forms a quote query for the corresponding extracted text. The quote query is configured to perform a string-matching search against the content of the source document 222. The quote query may be transmitted to the productivity application 110 as part of data communications 220.

To perform the string-matching search, the content of the source document 222 may be preprocessed to remove white spaces, change all characters to lowercase, and/or remove punctuation, among other types of preprocessing to increase the likelihood of a positive match for the substantive portion of the extracted text. In some examples, preprocessing the content from the source document 222 may also include performing spelling and/or grammar corrections. Due to the extensive training of some LLMs, even when the LLM 108 attempts to extract a verbatim quote from the source document 222, the LLM 108 may also make corrective changes to the verbatim quote, such as by removing additional spaces, adding or removing punctuation, and/or correcting spelling or grammar errors in the text from the source document 222. As such, the preprocessing of the source document 222 accommodates such changes by the LLM 108 where the quotation is still substantively correct and improves the accuracy of the verification process. Alternatively or additionally, the asserted quote in the LLM output may still be considered a match to the document when all but a set number or low percentage of the characters match content in the source document 222. For instance, a 95% match may still be considered a match, or a match may still be found when 5 or less characters in the extracted text string do not match.

The quote query may be executed against the content of the source document 222 by the AV application 112 and/or the productivity application 110. Where the quote query is executed by the productivity application 110, the quote query is transmitted to the productivity application 110. The results of the quote query are then transmitted back to the AV application 112 in data communications 220.

Where the quote query is executed by the AV application 112, the quote query need not be communicated to the productivity application 110. In addition, because the AV application 112 already received the content of the source document 222 when forming the LLM prompt, the AV application 112 already has the content of the source document 222 to execute the source query against.

The results of the query are used to determine whether the output of the LLM is verified. If all the quotes are found to match the content of the source document 222, the output from the LLM is considered to be fully verified. If some but not all of the quotes match the content of the source document 222, the LLM output is considered to be partially verified. The none of the quotes match the content of the source document 222, the LLM output is considered to be unverified. In some examples, when a quote is found to be verified, the source identifier for the quote (where included in the LLM output) may also be checked to determine if the position or location of the source identifier matches the position in the source document 222 where the matching quote was found as part of the verification process.

For examples where the LLM output is fully verified, an attribution verification indicator may be generated and incorporated in responsive results that are to be displayed in the application UI 106. For examples where the LLM output is partially verified, the quotes in the LLM output that do not match the source document 222 may be removed from the output when forming the responsive results for display. In other examples, the quotes that do match the source document 222 (e.g., the verified quotes) are formatted or marked differently from the quotes that do not match the source document 222 (e.g., the unverified quotes). For instance, a verification indicator may be incorporated adjacent each of the verified quotes. Alternatively or additionally, unverified indicators (e.g., UI elements indicating a quote is unverified) may be incorporated adjacent each of the unverified quotes. In other examples, a disclaimer or other general unverified indicator may be incorporated that indicates not all quotes could be verified.

For examples where all the quotes are unverified (e.g., none of the quotes could be verified), the LLM output may be discarded and the LLM prompt (or a revised LLM prompt) may be provided to the LLM 108 to be processed again to generate a second output from the LLM. The second output may then be analyzed for verification again. Alternatively or additionally, the responsive results that are provided for display may be an error message that indicates a verified summary and/or answer cannot be generated. In other examples, the original LLM output is retained, and an unverified indicator is incorporated into the responsive result to indicate that no quotes could be verified as being attributable to the content of the source document 222.

Additional modifications to the LLM output may also be made when generating the responsive result to the question and/or summary request. For example, the source indicators in the LLM output may be operationalized such that selection of the source indicator causes a jump to the corresponding portion of the source document 222. Operationalizing the source indicator may include adding link functionality to the source indicator. Other changes to the LLM output may include formatting or altering the LLM output to be in a format (e.g., particular syntax or code) that can be processed and displayed by the application UI 106. A date and/or time stamp may also be added to the responsive result. The responsive result is then transmitted to the productivity application 110 for display in the application UI 106, where the responsive results are presented to the user as data communication 225.

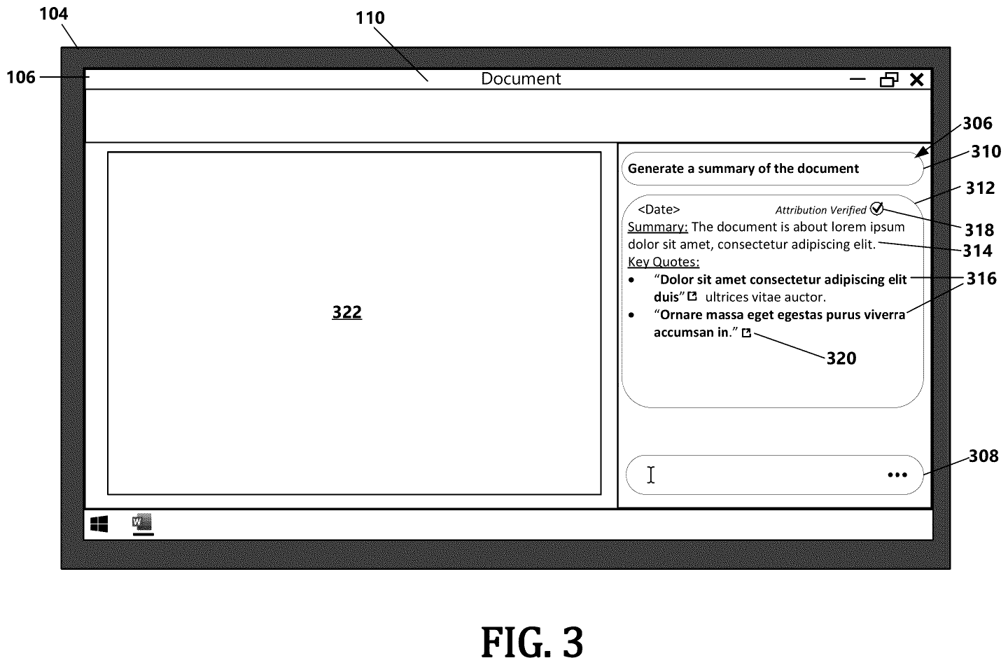

FIG. 3 depicts an example application UI 106 for a productivity application 110 displaying a source document and a verified LLM output. In FIG. 3, the example application UI 106 is depicted as a UI of a word-processing application 110 presented on a display 104. For instance, a user may use the slide presentation application 110 to compose or edit a source document 322 that includes texts, objects, images, and/or other data. The source document 322 is displayed withing a primary document viewing portion of the application UI 106.

The application UI 106 also includes a document interrogation sidebar or pane 306 that is displayed concurrently with the source document 322. The pane 306 includes UI elements for asking questions about the source document 322 or requesting data about or from the source document 322. The display of the pane 306 may be toggled based on user interactions. For instance, a selection of a UI element, such as in the ribbon of the application UI 106, may toggle the display of the pane 306. While the pane 306 is shown as being presented with the application UI 106 of a particular productivity application 110, the pane 306 may be accessed and/or presented via other interfaces as well. For instance, the pane 306 may be accessed when previewing a document from a file viewer or a productivity platform, such as the Microsoft 365 productivity platform.

The pane 306 may include a text input box 308 that receives inputs from a user for a request and/or question for the source document 322. When the request or question is entered into the input box 308, the request or question is provided to the productivity application 110 for processing along with the content of the source document 322.

The pane 306 also includes prior requests or questions along with the responsive results to those prior requests or questions. For instance, a prior-request UI element 310 indicates that a prior request was to “Generate a summary of the document.” The responsive results to the request are displayed in a responsive-results UI element 312. The example responsive results in FIG. 3 include a summary 314 that was generated from the LLM. The example responsive results also include two quotes 316 from the source document 322. The quotes 316 are provided within quotation marks and are provided in a bold formatting. The bold formatting may have been added by the LLM and provided as part of the output. In other examples, the bold formatting may be provided by the AV application upon verifying that the quotes are properly attributable to the source document 322. While the quotes 316 are displayed as being separated from the summary 314, in other examples, the quotes 316 may be integrated inline into the summary 314 (or answer).

In the example depicted, both of the quotes are verified. As a result, a verification indicator 318 is provided in the responsive results. The verification indicator 318 conveys to the user that the quotes within the responsive results have been verified and are properly attributable to the source document 322. The verification indicator 318 may be in the form of a graphic (e.g., circled checkmark) and/or text indicating the verification (e.g., “Attribution Verified”). Other examples are possible to indicate that the quotes in the LLM output are verified.

Each of the quotes 316 also include a source identifier 320 that has been operationalized as a link to the corresponding portion of the document. For instance, upon selection of one of the source indicators 320, the source document 322 is navigated (e.g., scrolled) to the portion of the source document 322 where the quote is presented. In some examples, other interactions with the source identifier causes the location of the quote (e.g., page and/or line number) of the quote 316 in the source document 322. For example, hovering over the source indicator 320 may cause a popup interface to display the location of the corresponding quote.

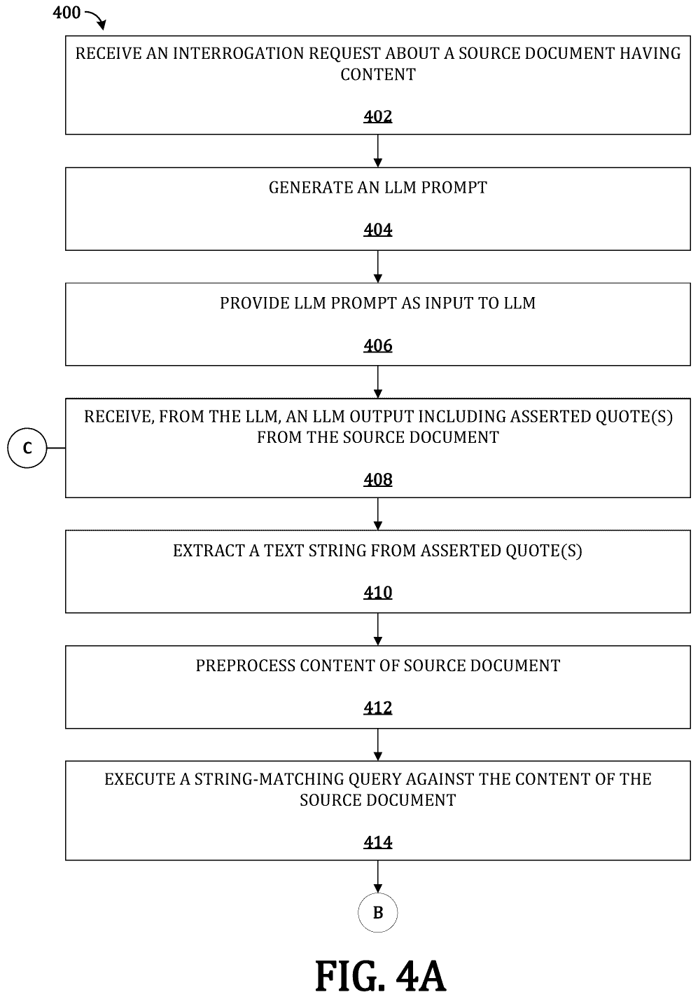

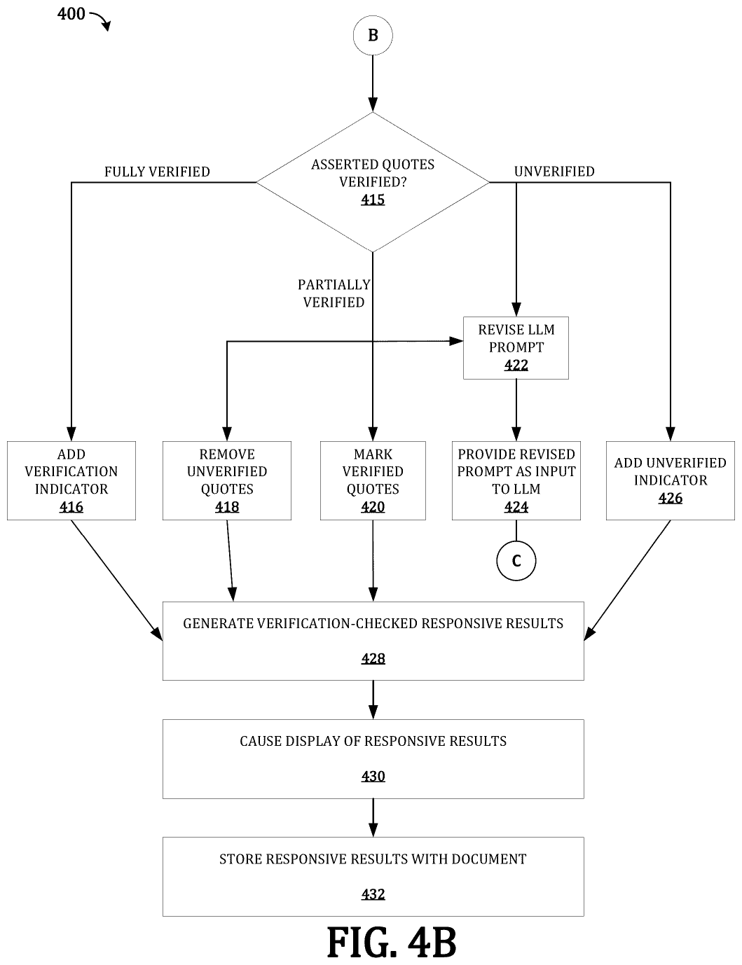

FIGS. 4A-4B depict an example method 400 for performing source document attribution verification. Method 400 may be implemented by a computing device, such as computing device 102 discussed above. In some examples, the method 400 is performed by the AV application 112.

At operation 402, an interrogation request, about a source document having content, is received. The interrogation request is a question or request that can be answered from the content of the source document. For example, the interrogation request may be a summarization request or a question about the document. The interrogation request may be based on user input, such as user input entered into an input box. In other examples, the interrogation request may be automatically generated upon the source document being first opened. For instance, a summarization request may be generated when a document is first opened or accessed.

At operation 404, an LLM prompt is generated that includes the interrogation request (or a portion thereof) and the content of the source document (or a portion thereof). The LLM prompt also include instructions and/or examples for causing the LLM to generate verbatim quotes from source document. The LLM prompt may include the features and/or elements discussed above.

At operation 406, the LLM prompt is provided as input to the LLM. The LLM then processes the LLM prompt to generate an LLM output. The LLM output includes one or more asserted quotes from the source document. As used herein, the “asserted quotes” are quotes that are in the output that the LLM is asserting are bona fide quotes from the source document. When generated from the LLM, however, the asserted quotes have not been verified and may actually be hallucinated content. At operation 408, the LLM output included the asserted quotes is received from the LLM.

At operation 410, the asserted quotes in the LLM output are parsed to extract a text string from each of the asserted quotes in the LLM output. Extracting the text strings may include detecting delimiters (e.g., quotation marks, bullet points, line breaks, bold or other formatted letters, etc.) and/or other identifiers (e.g., source identifiers) provided in the LLM output. The type of delimiter and/or identifier is based on the examples and/or instructions in the LLM prompt.

The extracted text string may be modified to improve the text string for use in performing a string-matching query. For example, the white spaces and/or punctuation may be removed from the extracted text string. The letter case of the text string may also be changed to all upper case or all lower case.

At operation 412, the content of the source document may also be modified to improve the content for use in performing a string-matching query. For instance, the white spaces and/or punctuation may be removed from the content. The case of the content may also be changed to all upper case or all lower case.

At operation 414, a string-matching query is executed against the content of the source document to determine if the asserted quotes of the LLM output are actually within content of the source document. The string-matching query may be performed using the modified extracted text string and/or the modified content of the source document. In some examples, the string-matching query may be performed using the LLM (or another LLM). For instance, a prompt including the content of the source document and instructions to determine if the extracted text string(s) are within the content of the source document. This additional processing by the LLM to determine the string matching, however, may be more computationally expensive than performing the string-matching query via other programmatic options, and therefore the programmatic options may be used instead of the LLM in some examples to perform the string matching.

At decision 415, a decision or determination is made as to whether the asserted quotes are verified. If all the quotes are fully verified, the method 400 flows to operation 416, where a verification indicator is added to the responsive results that are responsive to the interrogation request. The method 400 then flows to operation 428, where the responsive results are generated based on the verification of the asserted quotes. For example, where all the quotes have been verified, the responsive results include the verification indicator and the LLM output.

Returning to decision 415, if the asserted quotes are partially verified, the method 400 may flow to operation 418, operation 420, and/or operation 422. For example, the LLM output may include a first asserted quote and a second asserted quote. The first asserted quote may be determined to be unverified (e.g., there was no match in the source document content for the extracted text string of the first quote), and the second asserted quote may be determined to be verified.

At operation 418, the unverified quotes are removed from the LLM output. Thus, the unverified quotes are not included in the responsive results. Continuing with the example above, the first quote that was determined to be unverified is removed. At operation 420, which may be performed alternatively or in addition to operation 418, the verified quotes are marked as verified. Marking the verified quotes may be performed by including a verification indicator near the verified quote so as to indicate the verification of the quote. Marking the verified quotes may also include changing the formatting of the verified quotes, such as via bolding, underlining, or other types of formatting changes. In examples, where operation 418 is performed before operation 420, an overall verification indicator may be provided in the responsive results because the unverified quotes have been removed.

After operation 418 and/or operation 420, the method 400 flows to operation 428 where, as discussed above, the verification-checked responsive results are generated. Where operation 418 is performed, the responsive results are generated without the removed unverified quotes. Where operation 420 is performed, the responsive results are generated with the marked verified quotes and/or verification indicator.

Returning to decision 415, in some examples, when there is one or more unverified asserted quote in the LLM output, the method 400 flows to operation 422. At operation 422, the LLM prompt is revised. Because the prior LLM prompt caused the production of erroneous quotes, revision of the LLM prompt may cause subsequent processing by the LLM to produce more accurate quotes. In other examples, the same LLM prompt may be resubmitted to the LLM because the LLM likely will not generate the same output twice.

The LLM prompt may be revised by selecting an alternative prompt template, adjusting the emphasis on the verbatim quote suggestion, and/or adding additional context. At operation 424, the revised prompt is provided to the LLM. The LLM then processes the revised prompt to generate a revised LLM output. The method 400 may then flow back to operation 408 where the method repeats with the revised LLM output.

Returning again to decision 415, in examples where all the quotes are unverified, the method 400 may flow to operation 426 where an unverified indicator is added to the responsive results. The unverified indicator indicates that the quotes within the LLM output are unverified and/or there is low confidence in the result generated by the LLM. The method 400 then flows to operation 428, where the responsive results are generated with the unverified quotes of the LLM output and the unverified indicator.

After the responsive results are generated in operation 428 according to the verification status of the asserted quotes, the responsive results are caused to be displayed at operation 430. For instance, the responsive results may be transmitted for display in a pane of an application UI, such as the UI displayed in FIG. 3. Other forms of presenting or displaying the responsive results are also possible. For instance, the responsive results may be displayed with a preview of the source document or accessed via a productivity platform.

At operation 432, the responsive results may be stored with the source document. For example, where the interrogation request is to generate a summary or the document, that summary will not change unless the document changes. Accordingly, rather than having to expend computing resources to reprocess the summarization prompt by the LLM, the summarization results that have been verified may be stored or cached with the corresponding supporting document. Such storage or caching may be particularly useful for examples where a summarization request is automatically triggered when a source document is opened. In such examples, prior to triggering a summarization request, a determination may be made as to whether verified summarization results have been previously generated and stored with the document. If so, a new summarization request may not be issued unless substantial changes were made to the document subsequent to the prior summarization results being generated.

FIG. 5 is a block diagram illustrating physical components (e.g., hardware) of a computing device 500 with which examples of the present disclosure may be practiced. The computing device components described below may be suitable for one or more of the components of the system 100 described above. In a basic configuration, the computing device 500 includes at least one processor or processing unit 502 and a system memory 504. Depending on the configuration and type of computing device 500, the system memory 504 may comprise volatile storage (e.g., random access memory), non-volatile storage (e.g., read-only memory), flash memory, or any combination of such memories. The system memory 504 may include an operating system 505 and one or more program modules 506 suitable for running software applications 550, the attribution verification application 112, and other applications.

The operating system 505 may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including one or more of the stages of the method 400 illustrated in FIG. 4. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged, or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 500 on the single integrated circuit (chip). Examples of the present disclosure may also be practiced using other technologies capable of performing logical operations such as, for example, AND, OR, and NOT, including mechanical, optical, fluidic, and quantum technologies.

The computing device 500 may also have one or more input device(s) 512 such as a keyboard, a mouse, a pen, a sound input device, a touch input device, a camera, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include RF transmitter, receiver, and/or transceiver circuitry; universal serial bus (USB), parallel, and/or serial ports.

The term computer readable media as used herein includes volatile and nonvolatile, removable, and non-removable media implemented in any method or technology for storage of information, such as computer readable instructions, data structures, or program modules. The system memory 504, the removable storage device 509, and the non-removable storage device 510 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer readable media may be part of the computing device 500. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As should be appreciated from the foregoing, the present technology provides multiple technical improvements. For instance, via the particular prompt formations and details discussed herein, the likelihood of inaccurate or hallucinated data from an LLM is reduced. Moreover, even where inaccurate or hallucinated data is still produced, the present technology verifies the LLM output data to improve the accuracy of the results and prevent the output of misrepresented data from an LLM. Such improvements reduce the overall error rate of data generated from the query or request processes and enhances the reliability of LLM-based functionality.

In an aspect, the present technology relates to a system for performing attribution verification for outputs from a large language model (LLM). The system includes at least one processor; and memory storing instructions that, when executed by the at least one processor, cause the system to perform operations. The operations include receiving an interrogation request about a source document having content; generating an LLM prompt that includes the interrogation request, the content of the source document, and instructions for inclusion of verbatim quotes from the source document; providing the LLM prompt as input into an LLM; receiving, from the LLM, an LLM output including an asserted quote from the source document; extracting a text string from the asserted quote; executing a string-matching query against the content of the source document to determine that the text string is present in the content of the source document; based on the text string being present in the content of the source document, generating responsive results including the LLM output and a verification indicator indicating that the LLM output is verified; and causing the responsive results to be displayed.

In an example, the LLM output further includes a source identifier for the asserted quote. In a further example, generating the responsive results includes incorporating the source identifier as a link to a position of the asserted quote in the source document. In another example, the operations further include: receiving a selection of the source identifier; and in response to receiving the selection, causing a display of the source document positioned to show the asserted quote. In still another example, the interrogation request is one of a summarization request or a question about the source document that can be answered from the source document. In yet another example, the interrogation request is based on a user input. In a still further example, the interrogation request is automatically generated upon the source document being accessed. In still yet another example, the operations further include storing the responsive results with the source document.

In another aspect, the technology relates to a computer-implemented method for performing attribution verification for outputs from a large language model (LLM). The method includes receiving an interrogation request about a source document having content; generating a first LLM prompt that includes the interrogation request, the content of the source document, and instructions for inclusion of verbatim quotes from the source document; providing the LLM prompt as input into an LLM; receiving, from the LLM, an LLM output including a first asserted quote and a second asserted quote from the source document; extracting a first text string, from the first asserted quote, and a second text string from the second asserted quote; executing a string-matching query against the content of the source document to determine that the first text string is not present in the content of the source document and that the second text string is present in the content of the source document; based on the string-matching query, generating responsive results including the LLM output and a verification indicator; and causing the responsive results to be displayed.

In an example, generating the responsive results includes removing the first asserted quote. In another example, generating the responsive results includes marking the second asserted quote as verified with the verification indicator. In still another example, the LLM output further includes a first source identifier for the first asserted quote and a second source identifier for the second asserted quote. In yet another example, the interrogation request is automatically generated upon the source document being accessed. In a further example, the interrogation request is a summarization request. In still yet another example, executing the string-matching query further comprises preprocessing the extracted text string and the document content to perform at least one of removing white space, removing punctuation, or changing letter case.

In another aspect, the technology relates to a method for performing attribution verification for outputs from a large language model (LLM). The method includes receiving an interrogation request about a source document having content; generating a first LLM prompt that includes the interrogation request, the content of the source document, and first instructions for inclusion of verbatim quotes from the source document; providing the LLM prompt as input into an LLM; receiving, from the LLM, an LLM output including an asserted quote from the source document; extracting a text string from the asserted quote; executing a string-matching query against the content of the source document to determine that the text string is not present in the content of the source document; based on the text string not being present in the content of the source document, providing a second LLM prompt as input to the LLM, the second LLM prompt comprising the interrogation request, the content of the source document, and second instructions for inclusion of verbatim quotes from the source document.

In an example, the method further includes receiving a second output from the LLM; generating responsive results from the revised LLM output; and causing a display of the responsive results. In another example, the method further includes generating responsive results including the LLM output with the asserted quote and an unverified indicator; and causing a display of the responsive results. In a further example, the second LLM prompt is the same as the first LLM prompt. In yet another example, the method further includes revising the first LLM prompt to form the second LLM prompt, wherein revising the first LLM prompt includes adding additional emphasis on producing a verbatim quote in the second instructions.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A system for performing attribution verification for outputs from a large language model (LLM), comprising:
at least one processor; and
memory storing instructions that, when executed by the at least one processor, cause the system to perform operations comprising:
receiving an interrogation request about a source document having content;
generating an LLM prompt that includes the interrogation request, the content of the source document, and instructions for inclusion of verbatim quotes from the source document;
providing the LLM prompt as input into an LLM;
receiving, from the LLM, an LLM output including an asserted quote from the source document;
extracting a text string from the asserted quote;
executing a string-matching query against the content of the source document to determine that the text string is present in the content of the source document;
based on the text string being present in the content of the source document, generating responsive results including the LLM output and a verification indicator indicating that the LLM output is verified; and
causing the responsive results to be displayed.

2. The system of claim 1, wherein the LLM output further includes a source identifier for the asserted quote.

3. The system of claim 2, wherein generating the responsive results includes incorporating the source identifier as a link to a position of the asserted quote in the source document.

4. The system of claim 3, wherein the operations further comprise:
receiving a selection of the source identifier; and
in response to receiving the selection, causing a display of the source document positioned to show the asserted quote.

5. The system of claim 1, wherein the interrogation request is one of a summarization request or a question about the source document that can be answered from the source document.

6. The system of claim 1, wherein the interrogation request is based on a user input.

7. The system of claim 1, wherein the interrogation request is automatically generated upon the source document being accessed.

8. The system of claim 1, wherein the operations further comprise storing the responsive results with the source document.

9. A computer-implemented method for performing attribution verification for outputs from a large language model (LLM), comprising:
receiving an interrogation request about a source document having content;
generating a first LLM prompt that includes the interrogation request, the content of the source document, and instructions for inclusion of verbatim quotes from the source document;
providing the LLM prompt as input into an LLM;
receiving, from the LLM, an LLM output including a first asserted quote and a second asserted quote from the source document;
extracting a first text string, from the first asserted quote, and a second text string from the second asserted quote;
executing a string-matching query against the content of the source document to determine that the first text string is not present in the content of the source document and that the second text string is present in the content of the source document;
based on the string-matching query, generating responsive results including the LLM output and a verification indicator; and
causing the responsive results to be displayed.

10. The method of claim 9, wherein generating the responsive results includes removing the first asserted quote.

11. The method of claim 9, wherein generating the responsive results includes marking the second asserted quote as verified with the verification indicator.

12. The method of claim 9, wherein the LLM output further includes a first source identifier for the first asserted quote and a second source identifier for the second asserted quote.

13. The method of claim 9, wherein the interrogation request is automatically generated upon the source document being accessed.

14. The method of claim 9, wherein the interrogation request is a summarization request.

15. The method of claim 9, wherein executing the string-matching query further comprises preprocessing the extracted text string and the document content to perform at least one of removing white space, removing punctuation, or changing letter case.

16. A computer-implemented method for performing attribution verification for outputs from a large language model (LLM), comprising:
receiving an interrogation request about a source document having content;
generating a first LLM prompt that includes the interrogation request, the content of the source document, and first instructions for inclusion of verbatim quotes from the source document;
providing the LLM prompt as input into an LLM;
receiving, from the LLM, an LLM output including an asserted quote from the source document;
extracting a text string from the asserted quote;
executing a string-matching query against the content of the source document to determine that the text string is not present in the content of the source document;
based on the text string not being present in the content of the source document, providing a second LLM prompt as input to the LLM, the second LLM prompt comprising the interrogation request, the content of the source document, and second instructions for inclusion of verbatim quotes from the source document.

17. The method of claim 16, further comprising:
receiving a second output from the LLM;
generating responsive results from the revised LLM output; and
causing a display of the responsive results.

18. The method of claim 16, further comprising:
generating responsive results including the LLM output with the asserted quote and an unverified indicator; and
causing a display of the responsive results.

19. The method of claim 16, wherein the second LLM prompt is the same as the first LLM prompt.

20. The method of claim 16, further comprising revising the first LLM prompt to form the second LLM prompt, wherein revising the first LLM prompt includes adding additional emphasis on producing a verbatim quote in the second instructions.
